(19) United States
(12) Patent Application Publication
(10) Pub. No.: US 2001/0038049 A1
(43) Pub. Date: Nov. 8, 2001

(54) Arrangement of seats for knives on a cutting shaft in a shredding machine

(76) Inventor: Bernd Paper, Hofstetten (CH)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/810,806

(22) Filed: Mar. 15, 2001

Related U.S. Application Data
(63) Continuation of application No. 09/310,496, filed on May 12, 1999, now abandoned.

(30) Foreign Application Priority Data
May 12, 1998 (DE) 19821205.4
May 12, 1998 (DE) 19821207.0

(51) Int. Cl. B02C 18/18

(52) U.S. Cl. 241/189.1; 241/242

(57) ABSTRACT

The invention concerns a knife seat arrangement on a cutting shaft of a shredding machine, having a knife seat groove and cutting tool arranged therein, whereby the cutting tool, fastened so as to be detachable in the knife seat groove, adjoins a flat back surface on a flat front surface of a stop element and the stop element adjoins a corresponding end surface of the knife seat groove with a semicylindrical rear wall, whereby the stop element has a protrusion, situated in a form-locking manner in a corresponding recess of the groove bottom and directed inward, in the area of the groove bottom of the knife seat groove, said protrusion partially gripping under the cutting tool and adjoining it, so that the stop element is supported radially in the groove by the cutting tool. In addition, the invention concerns a knife seat arrangement in a shredding machine with knife seat recesses distributed about the periphery, spirally wound, whereby cutting tools can be placed in the knife seat recesses and a number of knife seat recesses are placed on a common radial shaft plane, so that several cutting tools are situated on a common, radial cutting tool flight circle, whereby, adjusted to the desired cutting force, the knife seat recesses of a common radial plane of the shaft are uniformly furnished with cutting tools and that knife seat recesses not furnished with cutting tools are covered or filled with cover elements.

The invention concerns an arrangement of seats for knives on a cutting shaft in a shredding machine in accordance with the preamble of claim 1.

A shredding machine, which is the subject of this invention, is shown in FIG. 16 and disclosed in DE 42 42 740 A1 and is used to shred and reduce wood, metal parts, plastic material, garbage and other waste materials.

The shredder 101 essentially consists of a material hopper 102, a feed unit 103 and a cutting tool 104. The three machine components 102, 103, 104 are connected to one another so as to be detachable by flanged couplings and, when assembled, form a feeding chamber 105. In the feeding chamber 105, a cutting shaft 106 driven by an electromotor engages in the lower area opposite the feed unit 103. The cutting shaft 106 is octagonal or polygonal in shape and is equipped with a number of cutting tools 107. The cutting tools 107 are fastened to the cutting shaft 106 and spirally wound and distributed over the periphery and are engaged with a first cutting plate 108 and a second cutting plate being used as a scraping bar. The upper side of the first cutting plate 108 is simultaneously part of the floor of the feed chamber 105. A perforated screen 111 fastened to reinforcing rings 110 is provided below the cutting shaft 106. A collecting tray 112 is situated below the sieve 111, a worm conveyor 113 being connected to the lowest point of said collecting tray for removing the crushed or shredded material. FIG. 10 shows the cutting shaft 16 in a perspective of a partial view, as seen from the feed chamber 105. The cutting shaft 106 has a number of cutting tools 107 which are attached to the cutting shaft 106 in a thread-like manner. The cutting tools 107 sit in the recesses 129 made in the cutting shaft 106. The recesses 129 extend from a first edge 140 of the cutting shaft 106 to the second edge 141 following in direction of rotation. The base 142 of the recess 129 deepens uniformly relative to a cutting shaft surface 139 over its entire longitudinal extension. The base 142 or the supporting area 131 forms a right angle with the contact surface 131. The height of the contact surface 131 between the second edge 141 and the base 142 corresponds to the diagonal extension of a cutting tool 107.

A shredding machine of this type is also shown in the brochure “Holzmag zerkleinerungstechnik” [Holzmag Shredding Technology] of Holzmag AG. In particular, a polygonal rotor shaft is shown which has knife seats and cutting tools inserted into the knife seats. The cutting tools are blocks rhombic in cross-section which are arranged in essentially V-shaped grooves which are distributed about the periphery of the shaft. The grooves are made in the shaft with bevelled cutters, which is why the end of the groove found in the shaft has a semicircular shape. The cutting tools, which have a flat rhombic front surface and a flat rhombic back surface, require a flat emplacement on the back of the knives in order to ensure an impact resistant fit in the grooves. To this end, semicircular positioning elements are inserted into the semicircular or semicylindrical groove ends and welded with the material of the shaft.

A shredding machine of this type has proven successful.

In the field of waste recyling and disposal of waste materials, disposal firms must respond more and more flexibly to the various materials to be processed. Thus, for example, not only hard materials such as plastic housings, plastic products, electronic parts or other breakable materials have to be crushed but also stretch materials, woven synthetic materials, carpets, threads and fibers of all types. In addition, the material to be cut can vary considerably in size and volume; for example, small-sized hollow plastic bodies (PET bottles) and plastic barrels must be handled. Experience has shown that unsatisfactory results are obtained with respect to the cutting operation when using a preset driving power for the cutting shaft and a preset size for the cutting tools.

The object of the invention is to create an arrangement of seats for knives on a cutting shaft with which different demands with respect to the cutting operation of the cutting shaft can be easily met.

The object is solved with the features of claim 1. Advantageous embodiments are characterized in the subclaims.

According to the invention, the groove for the knife seat is designed in such a way that knife positioning elements can be loosely inserted in the rear end area of the groove and are loosely mounted. The knife positioning elements or stop elements are kept radially covered by the cutting tool screwed into the knife seat and, in addition, centered by the back of the cutting tool.

The positioning surface or the positioning element can have a contour protruding beyond the shaft, which is preferably adapted to the contour of the knife, so that the knife is supported by the positioning element over the entire rear surface of the knife.

The knife positioning elements according to the invention are, like the knives, easily and quickly exchangeable, so that they can be exchanged for other knives having knife positioning elements adapted accordingly. In addition, it is advantageous that, when there is a damaging impact stress on the knife which e.g. leads to a deformation of the knife seat, the knife positioning element can be exchanged because it is merely inserted in a corresponding recess of the shaft and is not welded with the shaft. As a result, the energy expended when changing the knife position is considerably reduced.

According to the invention, a cutting shaft can also be equipped in such a way that, at a preset maximum driving power, it can be optimally designed for the material to be shredded.

According to the invention, at a constant driving power, a cutting shaft can be adjusted to the material to be shredded in such a way that cutting tools can be removed at certain points from the cutting tools that are spirally wound and distributed on the periphery of the cutting shaft and replaced by cover elements of the invention which cover the knife seat in a lid-like manner. This enables a reduction or increase of the number of tools at a constant driving power of the cutting shaft, i.e. the torque of the cutting shaft is distributed to different numbers of knives and thus adapted to the material to be chopped. With difficult-to-shred materials, as e.g. carpets or woven plastics, the force on the individual cutting tools can be appropriatley increased by reducing the tools, whereby the cover elements of the invention ensure that no chopped materials accumulate in the knife seats and contaminate the knife seats or that thread-like material to be chopped winds about the shaft in the area of the empty knife seats without being cut. With hard materials to be cut, the cover elements ensure that the grooves for the knife seats are not damaged.

The invention shall be described in the following by way of example and with reference to drawings, showing:

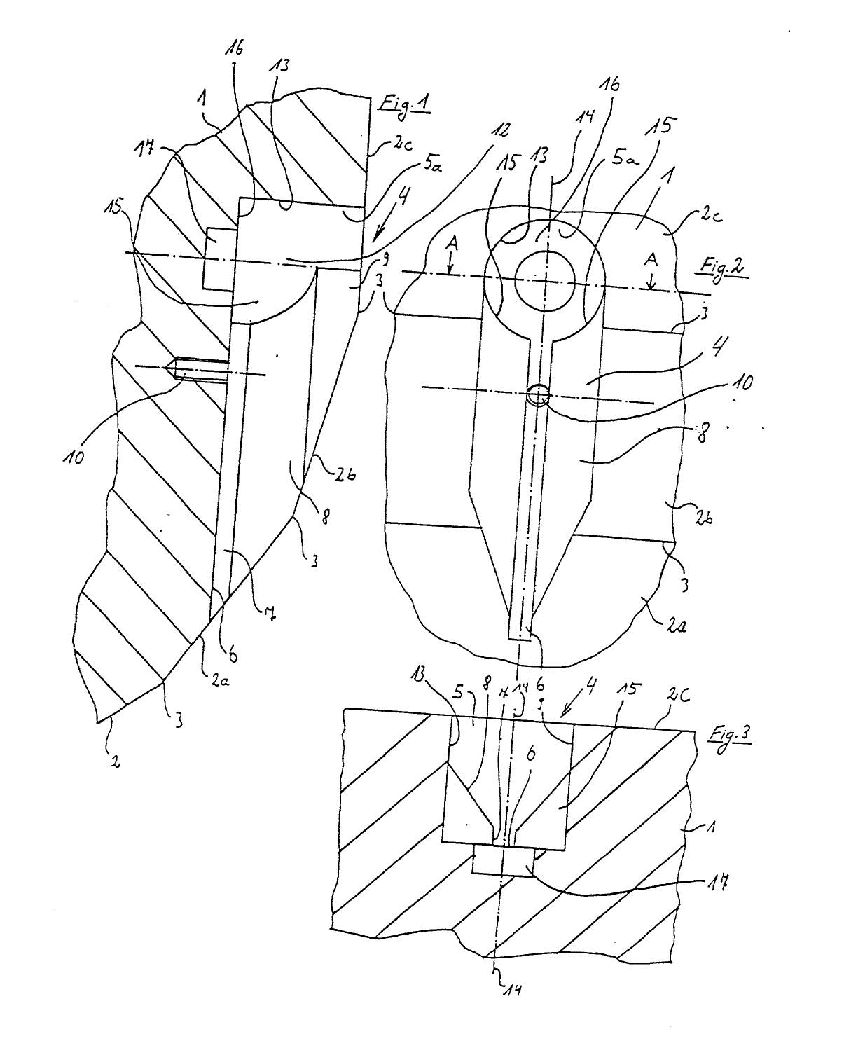

FIG. 1 the design of a knife seat groove according to the invention in a polygonal knife shaft in a sectional view through the shaft,

FIG. 2 a top view onto the knife seat groove according to FIG. 1,

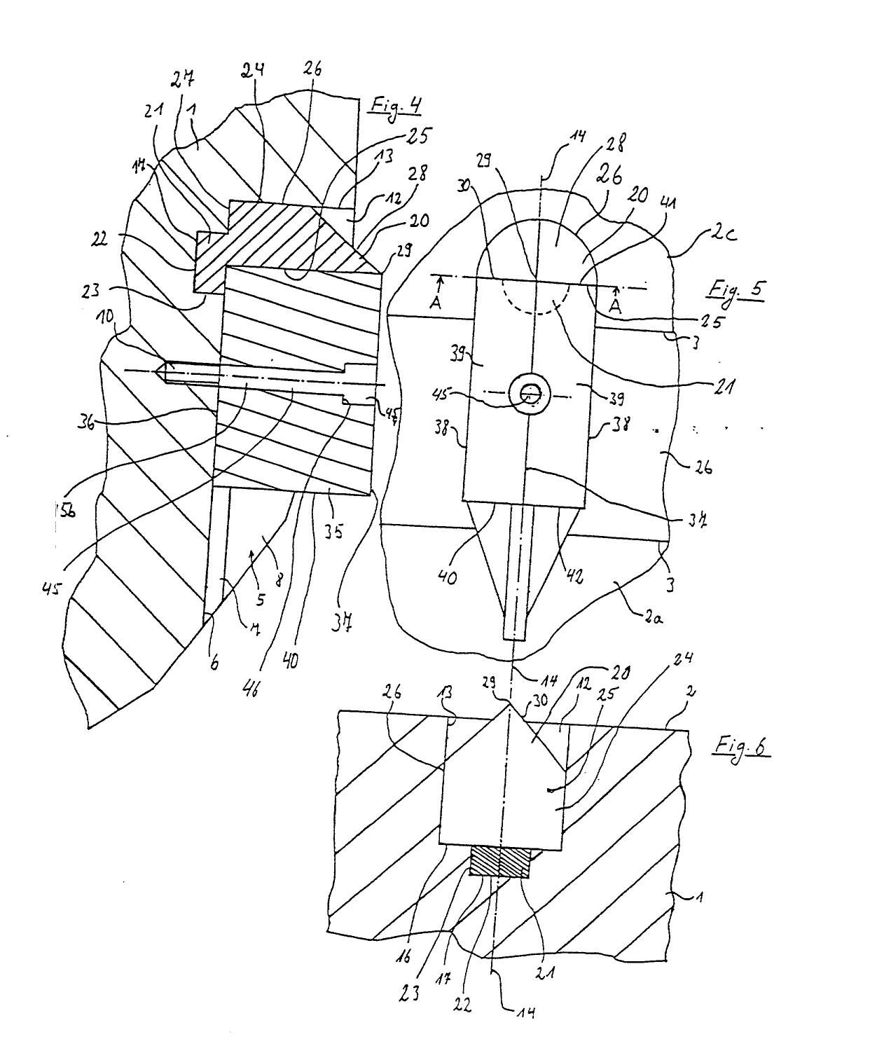

FIG. 3 a section along the line A-A in FIG. 2 through the knife seat groove,

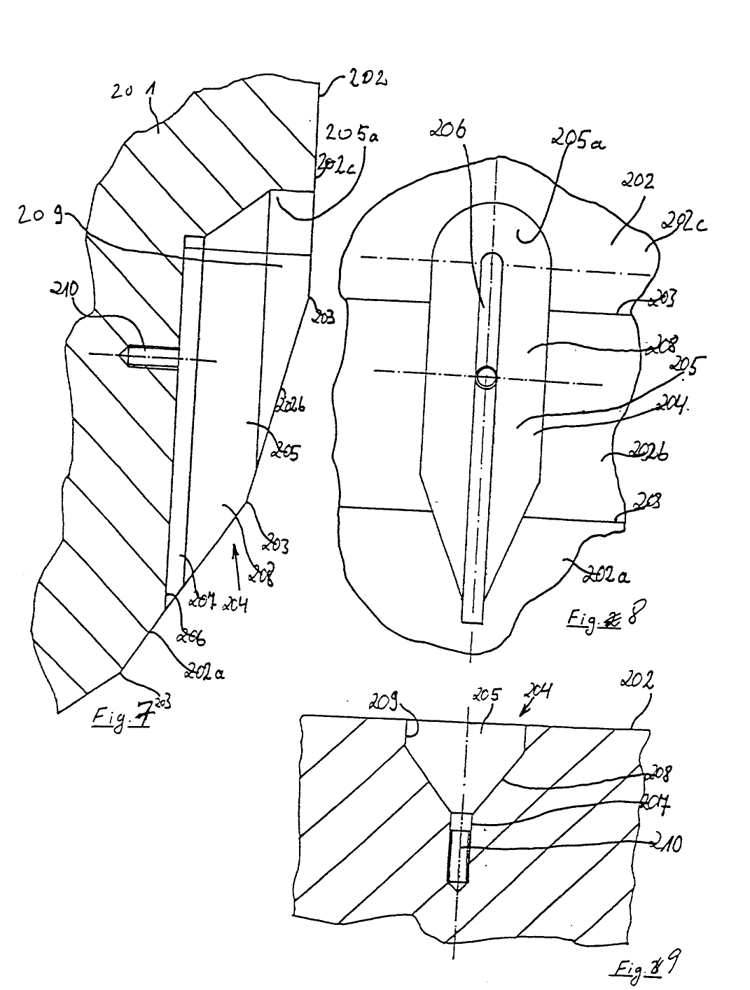

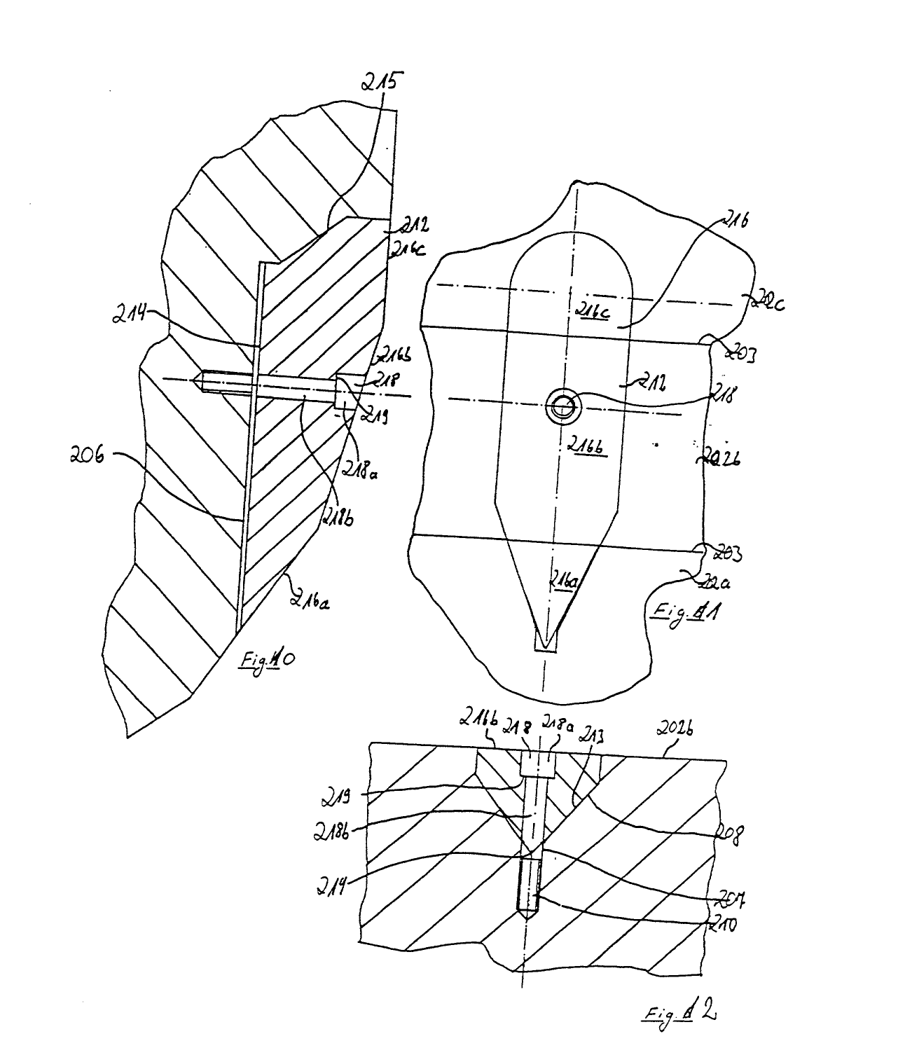

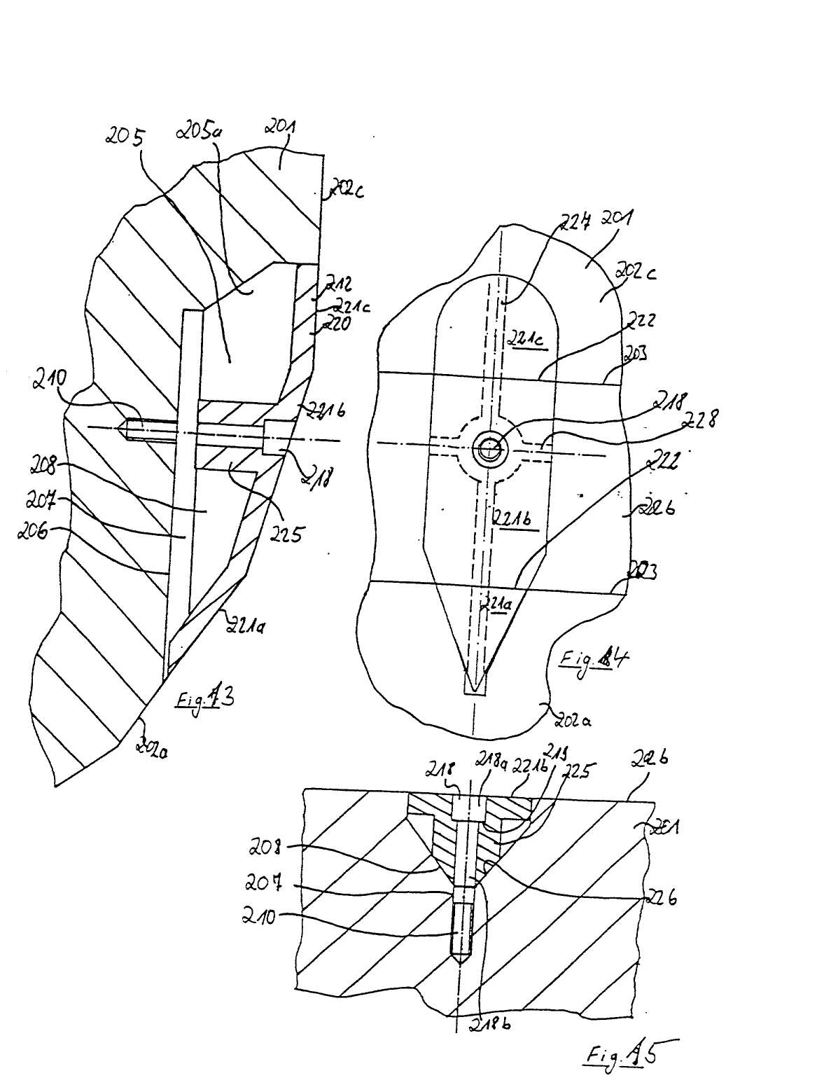

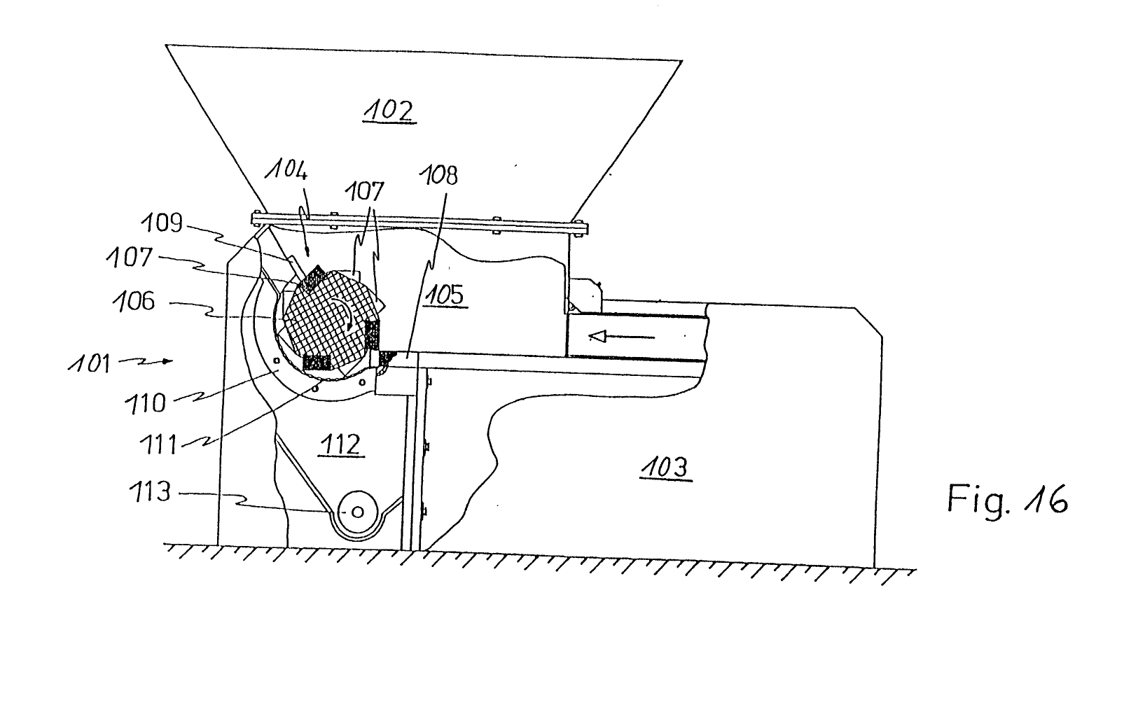

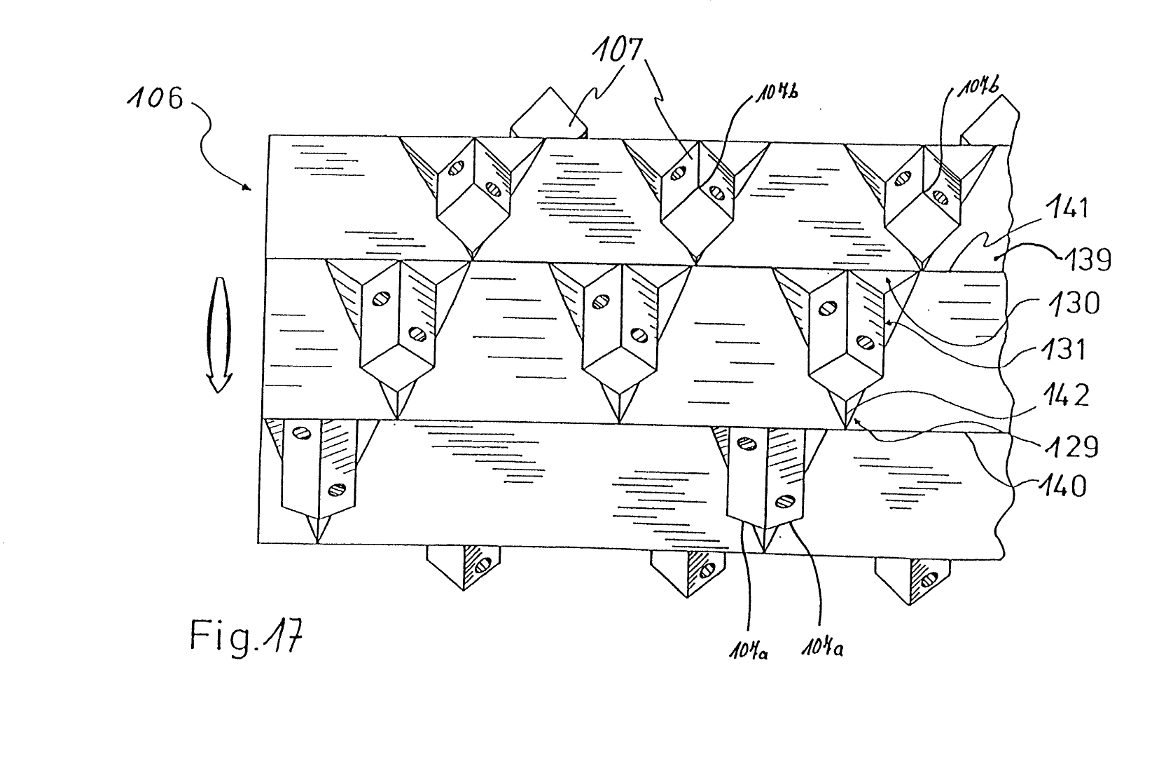

FIG. 4 a knife seat arrangement according to the invention having a knife positioning element and an inserted cutting tool in a section diagonal to the shaft,

FIG. 5 the arrangement of FIG. 4 in a top view onto the shaft,

FIG. 6 the arrangement of FIG. 4 in a section along the line A-A in FIG. 1, in a top view onto the bearing surface of the knife positioning element,

FIG. 7 a knife seat placed in a cutting shaft, in a longitudinal section diagonal to the longitudinal extension of the shaft,

FIG. 8 a knife seat according to FIG. 7 in a top view,

FIG. 9 a knife seat according to FIG. 7 in a section along the longitudinal extension of the shaft,

FIG. 10 a cover element according to the invention in a knife seat according to FIG. 7,

FIG. 11 a cover element of the invention in a knife seat according to FIG. 8,

FIG. 12 a cover element of the invention in a knife seat according to FIG. 9,

FIG. 13 a further embodiment of the cover element according to the invention in a knife seat according to FIG. 7,

FIG. 14 a further embodiment of a cover element according to the invention a s a hollow profile having reinforcing ribs in a knife seat as per FIG. 8,

FIG. 15 a cover element according to the invention as per FIG. 13 in a knife seat as per FIG. 9,

FIG. 16 a known shredding machine having a cutting shaft and cutting tools attached thereto,

FIG. 17 a cutting shaft of a shredding machine as per FIG. 16, in a top view.

A cutting shaft 1 (FIGS. 1 to 3) for accommodating cutting knives or cutting tools is, for example, a cutting shaft 1 having a polygonal cross section. Flat surfaces 2, which meet one another with edges 3, are formed by the polygonal cross section, whereby the edges 3 extend parallel to a longitudinal axis 6, preferably uniformly distributed about the periphery of the polygonal cutting shaft 6. Uniformly or regularly distributed knife seats 6 are mounted spirally wound on the periphery of the cutting shaft 1. The knife seats 4 are grooves 5 that are funnel-shaped in cross section with a flat groove bottom 6. The groove bottom 6 or the grooves 5 extend as hexagons from a surface 2 into the cutting shaft 1. The groove 5 begins at about the transverse axis of a surface 21, extens over the entire width of the next surface 2b and ends at approx. the transverse axis of the next surface 2c but one. Due to the hexagonal arrangement of the groove bottom, the groove becomes deeper from the first surface 2a to the last surface 2. The groove which is funnel-shaped in cross section ends in the area of surface 2c with a semicylindrical rounded end 5a. In the conical area of the final area 5a, the groove 5 has flat groove bottoms 6 and short walls 7 extending tangentially upward from the flat groove bottom 6, so that the groove 5 above the groove bottom 6 is a rectangular or square groove. The groove expands with diagonal walls 8 from the short walls 7. Tangential straight walls 9 extend from the diagonal walls 8 to the surface of the cutting shaft 1 or the surface 2c. In the area of the surface 2c, the groove 5 has a constant height. The groove depth decreases successively from the edge 3 between the surface 2c and surface 2b to the edge 3 between the surface 2b and surface 2a, so that the height of the wall sections 9 of the groove 5 becomes less and less until the wall sections 9 disappear in the area of the edge 3 between surfaces 2b and 2a. The depth or height of the groove 5 continues to decrease from the edge 3 between the surface 2b and surface 2a to the emergence of the groove bottom in the surface 2a and increasingly about the slope of surface 2a to surface 2b.

In the area of surface 2b, a bore 10 is placed in the groove bottom at right angles to the groove bottom 6. The bore 10 serves to accommodate a setscrew (not shown) for cutting tools.

In the area of the end 5, the groove is formed from the upper surface 2c to the level of the groove bottom 6 as a cylindrical bore, so that the groove 5 has a semicylindrical wall 13 at right angles to the surface 2c in the area of end 5a. Adjacent to the walls 8, pointing in direction of the outlet of groove 5, cylinder casing sector-shaped walls 15 are formed on both sides of the transverse axis 14 of groove 5 and adjacent to wall 13. The flat groove bottom 6 opens at the end into a circular groove bottom 16. A cylindrical recess or bore 17 is placed in the bottom 16 so as to be axially aligned to the bore 13.

The stop element or positioning element 20 of the invention has a cylindrical foot plate 21 with a circular disk-shaped cylinder bottom wall and a cylinder jacket wall 23. A semicylindrical section 24 of the body 20 extends from the foot plate 21 away from the foot plate 21. The semicylindrical section 24 has a flat front surface 25 and a casing wall or back surface 26 which is semicircular in cross section. The flat surface or wall 25 aligns with an axial plane of the foot plate 21, whereby the radius of the cylinder casing wall 26 is larger than the radius of the casing wall 23 of the foot plate 21, so that the cylindrical section 24 forming a step 27 protrudes beyond half of the cylindrical foot plate 21. The casing wall 20 of the area 24 tapers in from of a cone-shaped shell wall 28 up to a point 29, so that the flat wall 25 tapers vis-à-vis the foot plate 21 in a inversed V-shaped manner to the point 29, forming an edge 30.

The foot plate 21 corresponds with the bore 17 and fits into it in a form-locking manner, at the top, it closes with the groove bottom 6. The casing wall 26 corresponds with the bore wall 13, so that the stop element 20 is disposed in the end area 5a of the groove 5, whereby the foot plate rests in the bore 17 and the cylinder wall 26 adjoins the bore wall 13 in a form-locking manner. Step 27 rests in a form-locking manner on surface 16.

A cutting tool 35 to be placed in the groove is a longitudinal block 35, rhombic in cross section, having a lower longitudinal edge 36 pointing into the groove 5, an upper longitudinal edge 37, two side longitudinal edges 38 and four surfaces 39 that have the same angle to one anther. The rhombus forms a cutting tool face surface 40 pointing out of the groove and a cutting tool rear surface 41 pointing toward the groove end 51. The surfaces 39 and surface 40 form an inverse V-shaped cutting edge 42 that points outward. Extending from edge 37 to edge 36, a bore is placed at about the longitudinal axis of the cutting tool, which has a wide bore area 45a in the vicinity of edge 27 that becomes narrower with a step 46 to form a narrower bore area.

The arrangement of the stop element 20 and a cutting tool 35 in a groove 5 or in a knife seat 4 will be described in the following. First, the stop element 20 is inserted into the bore 17 with the foot plate 21, so that the cylinder casing wall 26 of area 24 adjoins the bore wall 13. A cutting tool 35 is then pushed into the groove until the cutting tool surface 41 or rear knife surface adjoins surface 25 in a form-locking manner. The cutting tool 35 lies on the surfaces 8 of the groove 5 and, with the longitudinal edge 36, on the groove bottom 6 and, at the top, on the foot plate 21, radially covering the latter. A screw bolt (not shown) is then inserted through the bore or the hole 45 and then screwed into the bore 10 of the cutting shaft which is aligned with the bore 45. By fastening the cutting tools to the shaft, the stop element 20 is also fastened to the cutting shaft 1 due to the pressure of the longitudinal edge 36 on the foot plate 21. The edge 30 of the stop element 20 closes with the surfaces 39 and the upper longitudinal edge 37 of the cutting tool.

In a further embodiment, the upper side of the protrusion 21 is designed V-shaped, protruding beyond the groove bottom 6, whereby the groove bottom 6 horizontally aligns or seals with the base of the V-shaped protrusion. In this embodiment, the protrusion 21 holohedrally adjoins the lower diagonal surfaces and the edge 36 of a cutting tool in a form-locking manner. As a result, a centering or alignment of the stop element is obtained when the cutting tool is inserted.

If the surfaces 39 of the cutting tool are contoured, for example, contoured with teeth that point outward, the edge 30 of the stop element 20 can be formed accordingly, so that the cutting tool is holohedrally supported by the stop element in the area of the surface 39 adjacent to the longitudinal edge 37.

The stop element 20 can, adjusted to the material of the cutting tool, consist of hard metal, metal, ceramics or the like. In addition, various stop elements 20 can be used for different cutting contours of the cutting tools, which are exchanged when the knives are exchanged. Furthermore, protrusions can be formed on the rear surface of the stop element, said protrusions fitting in appropriate corresponding recesses of the rounded end wall of the groove, so that the stop elements are hereby radially secured.

If the number of cutting tools on the cutting shaft is reduced, the setscrew is unscrewed and the cutting tool removed. The stop element 20 is then removed, after which a cover piece (not shown) is pushed onto the empty groove 5 or into the empty knive seat 5 and screwed in the bore 10.

In the design of a knife seat according to the invention and the stop elements of the invention, it is advantageous that the stop elements can be easily removed. As a result, the stop elements can be easily removed when there is damage. In addition, the stop elements can be adjusted to the various forms of the cutting tool or materials and be inserted together with the knives. Furthermore, it is advantageous that the stop elements do not have to be unwelded after damage has occurred.

In the embodiment of the invention according to FIGS. 8 to 16, a cutting shaft 201, for example a cutting shaft having a polygonal cross section, is shown for accommodating cutting knives or cutting tools. Due to the polygonal cross section, flat surfaces 202 are formed which meet at their edges 203, whereby the edges 203, extending parallel to a longitudinal axis of the shaft 201, are preferably uniformly distributed on the polygonal cutting shaft 206. Uniformly or regularly distributed knife seats 204, wound spirally, are placed on the periphery of the cutting shaft 201. The knife seats 204 are grooves 205, funnel-shaped in cross section with a flat groove bottom 206. The groove bottom 206 or the grooves 205 extend as hexagons from a surface 202 into the cutting shaft 201. The groove begins at about the transverse axis of a surface 202a, extends over the entire width of the next surface 202b and ends approx. at the transverse axis of the next surface 202c but one. Due to the hexagonal arrangement of the groove bottom, the groove becomes deeper from the first surface 202a to the final surface 202c. The groove, funnel-shaped in cross section, ends in the area of the surface 202c with a semi-tapered funnel-shaped, rounded end 205a. The groove 205 has the flat groove bottom 206 and the short walls 207 extending tangentially upward from the flat groove bottom 206 in this area, so that the groove 205 is a rectangular or square groove above the groove bottom 206. The groove expands from the short walls 207 with diagonal walls 208. Straight walls 209 extend tangentially from the diagonal walls 208 to the surface of the cutting shaft 201 or surface 202c. In the area of surface 202c, the groove 205 has a constant height. The groove depth declines successively from the edge 203 between the surface 202c and surface 202b to the edge 203 between the surface 202b and surface 202a and increasingly declines from edge 203 between surface 202b and surface 202a to the bottom of the groove where the groove ends at surface 202a, again by the slope of surface 202a to surface 202b.

The diagonal walls 208 serve as bearings for cutting tools. In the area of surface 202b, a bore 210 is placed in the groove bottom at right angles to the groove bottom 206. The bore 210 serves to accommodate a setscrew for cutting tools.

The cover element 212 of the invention (FIGS. 11 to 13) is solid, e.g. made of metal or a ceramic, and points to walls 213 corresponding to the diagonal walls 208 which meet at a common edge 214. When the cover element 212 is placed in the groove 205, the edge 214 is situated between the short walls 207 and is preferably slightly spaced from the bottom of the groove 206. The remaining surfaces of the cover element 212 correspond to the groove, so that the cover element 212 is made so as to be in the shape of a semicircular cone in the area of a surface 202c or the groove end 205a and tapers from the semicircular conically shaped end 215 along the groove 205, whereby the cover element 212 has surfaces 216a, 216b and 216c pointing outward and oriented at an angle to one another, which each align or close with the surfaces 202a, 202b and 202c of the polygonal cutting shaft 201.

Aligned with the bore 210, the cover element 212 has a bore 218 made in the cover element from the surface 216b at a right angle to the edge 214 and which becomes narrower from a further area 218a with a step 219 to a narrower area 218b. A threaded bolt is inserted through the bore 218 or hole 18 and screwed into the threaded bore 210 of the shaft in order to rigidly fix the cover element 212 in the groove.

In a further embodiment of the cover element (FIGS. 14 to 16), the cover element 212 is shaped like a hollow profile in the form of a plate 220 that is bent twice, whereby three surfaces 221a, 221b and 221c are formed by the bending, which meet at the crease edges 222. The outer form of the plate 220 corresponds to the form of the groove 205 or the shaft 201, adjacent to the surfaces 202a, 202b, 202c, so that, when the cover element 212 has been pushed into the groove 205, the plate 220 seals in a form-locking manner on the outside.

The plate 220 has a cylindrical formation 225 in direction of the bore 210 in the groove bottom 206 which is formed, in the area of the diagonal walls 208 of the groove 205, with diagonal supporting walls 226 corresponding to the walls 208. A bore 218 for accommodating a screw bolt is also placed in this plate 220 in the area of the formation 225. In a further embodiment (FIG. 15), a reinforcing rib 227 is situated on the underside and a transverse reinforcing rib 228 diagonally thereto, following the longitudinal slope of the cover element 212.

The use of the cover element is described in the following.

In order to apply an increased force on the individual cutting tools at a preset driving power and the constant speed of the cutting shaft, it is necessary to reduce the number of knives. Usually several cutting tools, e.g. up to eight, are found on a cutting tool flight circle or a common, radial plane of the shaft with cutting tools generally spirally wound and distributed over the periphery, so that during a rotation of the shaft a cut is made eight times in this flight circle. The number of knives can, for example, be halved on a knife flight circle, so that only four cuts are made during a rotation. The empty four knife seats or grooves are covered with the cover element of the invention, whereby it is advantageous that the cover elements prevent material from accumulating in the groove or prevent difficult-to-cut material, such as e.g. carpets, from catching on empty grooves 205 and winding about the shaft without being cut. With hard material to be cut, the cover elements prevent the knife seat grooves not equipped with knives from being damaged by the materials. Moreover, it is advantageous that the cover element can be manufactured in an especially simple and easy manner, for example, by metal casting.

By providing cover elements, it is thus possible to quickly refit a conventional cutting shaft to various types of materials. As a result of the form of the cover element corresponding to the groove and the fastening of the cover element with a screw connection equivalent to the knives, the refitting can be easily and especially quickly obtained.

1. Knife seat arrangement on a cutting shaft of a shredding machine, having a knife seat groove and cutting tool arranged therein, whereby the cutting tool fastened in the knife seat groove so as to be detachable adjoins a flat front surface of a stop element with its flat back surface and the stop element adjoins a corresponding end surface of the knife seat groove with a semicylindrical rear wall,
characterized therein
that the stop element (20) in the area of the groove bottom (6) of the knife seat groove (5) has a protrusion (21) directed into the shaft which, in particular, is situated in a form-locking manner in a corresponding recess of the groove bottom, which partially grips under the cutting tool (35) and adjoins it, so that the stop element (20) is radially supported by the cutting tool (35) in the groove.

2. Knife seat arrangement according to claim 1,
characterized therein
that the protrusion of the stop element is a cylindrical foot plate (21) having a circular cylindrical bottom wall (22) and a cylinder casing wall (23).

3. Knife seat arrangement according to claim 1 and/or 2,
characterized therein
that the semicylindrical section (24) of the stop element (20) extends over the back half of the foot plate (21), whereby the semicylindrical section (24) has the flat front surface (25) and the casing wall or rear surface (26) which is semicircular in cross section.

4. Knife seat arrangement according to one of the preceding claims,
characterized therein
that the flat wall (25) aligns with an axial plane of the foot plate (21), whereby the radius of the cylinder casing wall (26) is larger than the radius of the casing wall (23) of the foot plate (21), so that the cylindrical section (24) projects beyond half of the cylindrical foot plate (21), forming a step 27.

5. Knife seat arrangement according to one or more of the preceding claims,
characterized therein
that the casing wall (20) of the area (24) tapers in the form of a conical casing wall (28) to a point (29) vis-à-vis the foot plate (21), so that the flat wall (25) tapers vis-à-vis the foot plate (21) in an inverted V-shape to the point (29), forming an edge (30).

6. Knife seat arrangement according to one or more of the preceding claims,
characterized therein
that the foot plate (21) rests in a cylindrical bore (17) of the knife groove (5) so as to be form-locked and detachable, whereby the step (27) on the surface (16) of the casing wall (26) adjoins a groove wall (13) in a form-locking manner.

7. Knife seat arrangement according to one or more of the preceding claims,
characterized therein
that the cutting tool (35) is an elongated block, rhombic in cross section, having a lower longitudinal edge (36) pointing to the bottom (6) of the groove (5) and an upper longitudinal edge (37) as well as two side longitudinal edges (38) and a cutting tool front surface (40) and a cutting tool back surface (41), whereby the longitudinal edge (36) rests on the groove bottom (6) and on the protrusion (21) at the top.

8. Knife seat arrangement according to one or more of the preceding claims,
characterized therein
that the edge (30) of the stop element (20) closes with upper surfaces of the cutting tool (35) adjacent to the edge 37.

9. Knife seat arrangement according to one or more of the preceding claims,
characterized therein
that the edge (30) of the stop element (20) has, in contoured surfaces (39) of the cutting tool (35), the same contour and closes with the contoured surfaces (39) of the cutting tool (35).

10. Knife seat arrangement according to one or more of the preceding claims,
characterized therein
that the front surface (25) of the stop element (20) adjoins the back surface (41) of the cutting tool (35) over the entire surface.

11. Knife seat arrangement according to one or more of the preceding claims,
characterized therein
that the stop element (20) consists of hard metal, metal, ceramics or synthetic materials.

12. Knife seat arrangement according to one or more of the preceding claims,
characterized therein
that means are provided on the back surface (26) of the stop element (20) which engage with corresponding means of the corresponding groove wall (13).

13. Knife seat arrangement according to one or more of the preceding claims,
characterized therein
that the surface underneath the cutting tool of the foot plate (21) or the protrusion (21), forming a V-shaped groove, protrudes beyond the level of the bottom (6) of the groove (5), whereby the V-shaped groove of the foot plate is designed in such a way that the foot plate (21) adjoins the lower diagonal surfaces and the lower longitudinal edge (36) of a cutting tool in a form-locking manner over the entire surface at the top.

14. Knife seat arrangement, in particular according to one or more of claims 1 to 13,
characterized therein
that, adjusted to a desired cutting operation, the knife seat recesses (204) of a common radial plane of the shaft (201) are uniformly equipped with cutting tools and that certain knife seat recesses (204) are not equipped with a cutting tool and are covered with a cover element that can be secured in a lid-like manner.

15. Knife seat arrangement according to claim 14,
characterized therein
that the knife seat recesses (204) are essential V-shaped grooves (205) and that the cover element (212) has means (213, 225) with which it obtains a closed form, at least partially with the wall aeas (208) forming the groove (205) and has a surface (216) pointing outward which corresponds to the contour of the cutting shaft (201) in the area of the groove (205) and closes with the surface of the cutting shaft (202).

16. Knife seat arrangement according to claim 14 and/or 15,
characterized therein
that the surface (216) of the cover element (212) is formed with flat surfaces (216a, 216b, 216c) at an angle to one another, which close with the flat surfaces (202) at an angle to one another of a polygonal cutting shaft (201).

17. Knife seat arrangement according to one or more of claims 14 to 16,
characterized therein
that the surface (216) of the cover element (212) is round, in particular, cylinder casing sector-shaped and closes with the surface of a cylindrical cutting shaft (201).

18. Knife seat arrangement according to one or more of claims 14 to 17,
characterized therein
that the cover element (212) is solid, filling the knife seat recess almost completely, and closing with the surface of the cutting shaft.

19. Knife seat arrangement according to one or more of claims 14 to 18,
characterized therein
that the cover element (212) is made of metal, ceramics or synthetic materials.

20. Knife seat arrangement according to one or more of claims 14 to 19,
characterized therein
that the cover element (212) has walls (213) corresponding to the surfaces (208) defining the groove (205).

21. Knife seat arrangement according to one or more of claims 14 to 20,
characterized therein
that the cover element (212) has a bore which is placed radially in the cover element (212) with respect to the arrangement of the cover element (212) on a shaft (201)

22. Knife seat arrangement according to one or more of claims 14 to 21,
characterized therein
that the cover element (212) is in the form of a hollow profile having a plate (220) closing the shaft with the outer surface, whereby means (225) are provided on the plate (220) with which the plate (22) supports itself in the groove (205) on the surfaces (208) defining the groove (205).

23. Knife seat arrangement according to one or more of claims 14 to 22,
characterized therein
that the cutting shaft has a polygonal shape with a number of flat surfaces (202) that are at an angle to one another.

24. Knife seat arrangement according to one or more of claims 14 to 23,
characterized therein
that the knife seats (204) are grooves (205), funnel-shaped in cross section and having a flat groove bottom (206), where the groove bottom (206) or the grooves (205) are arranged as hexagons extending from a surface (202) into the cutting shaft (201).

25. Knife seat arrangement according to one or more of claims 14 to 24,
characterized therein
that the groove (201) starts at about the transverse axis of a surface (202a), extends over the entire width of the next surface (202b), opposite the direction of rotation, and ends at about the transverse axis of the next surface (202c) but one in direction of rotation.

26. Knife seat arrangement according to one or more of claims 14 to 25,
characterized therein
that the groove (205) extends hexagonally to the longitudinal axis of the shaft from a surface (202a) of the polygonal shaft to the surface (202c) in whose area the groove (205) ends and deepens.

27. Knife seat arrangement according to one or more of claims 14 to 26,
characterized therein
that the groove having a funnel-shaped cross section ends with a semi-conical funnel-shaped rounded end (205a) in the area of the surface (202c).

28. Knife seat arrangement according to one or more of claims 14 to 27,
characterized therein
that the groove (205) has a flat groove bottom (206) in the area of the end (205a) and short walls (207) and extending from the flat groove bottom (206) at right angles to the surface (202) of the shaft and to the groove bottom (206), so that the groove (205) has a rectangular or square groove shape above the groove bottom (206).

29. Knife seat arrangement according to one or more of claims 14 to 28,
characterized therein
that the groove (205) with diagonal walls (208) extends outward from the short walls (207), whereby the diagonal walls (208) are bearing surfaces for cutting tools or cover elements (212).

30. Knife seat arrangement according to one or more of claims 14 to 29,
characterized therein
that tangential straight walls (209) extend from the diagonal walls (208) to the surface of the cutting shaft (201) or surface (202c).

31. Knife seat arrangement according to one or more of claims 14 to 30,
characterized therein
that, in the area of the surface (202a), the groove (205) has a constant height, whereby the depth of the groove declines from an edge (203) between the surface (202c) and the surface (202b) successively to the edge (203) between the surface (202b) and the surface (202a) and that the groove depth declines more intensely until the groove bottom (206) ends on the surface (202a) from the edge (203) between the surface (202b) and surface (202a), by the slope of the surface (202a) to surface (202b).

32. Knife seat arrangement according to one or more of claims 14 to 31,
characterized therein
that a bore (210) is placed in the bottom of the groove (206), at a right angle to the groove bottom, in the area of the surface (202b).
